(19) United States
(12) Patent Application Publication
(10) Pub. No.: US 2003/0193528 A1
(43) Pub. Date: Oct. 16, 2003

(54) Hierarchical data structure which enables interactive visualization of a geographical space

(76) Inventors: Mark E. Stegbauer, Southgate, MI (US); Jeffrey M. Roberts, Commerce, MI (US)

Correspondence Address: HARNESS, DICKEY & PIERCE, P.L.C., P.O. BOX 828, BLOOMFIELD HILLS, MI, 48303, US

(21) Appl. No.: 10/264,133

(22) Filed: Oct. 3, 2002

Related U.S. Application Data
(63) Continuation-in-part of application No. 10/122,443, filed on Apr. 12, 2002.

(51) Int. Cl. G09G 5/00

(52) U.S. Cl. 345/853

(57) ABSTRACT

An interactive visualization tool is provided that enables its users to build, modify and interactively view three-dimensional simulation models of a particular geographical space. The interactive visualization tool employs a scene definition data structure that represents the geographical space. The scene definition data structure is comprised of a plurality of data records, where each record represents a physical structure residing in the geographical space. Each data record includes an identifier for the physical structure, link data which provides information to access corresponding model data for the physical structure, position data which provides positional information for the physical structure in the geographical scene, and hierarchical data which indicates the number of data records having a child relationship thereto.

### FIELD OF THE INVENTION

The present invention relates generally to an interactive visualization tool and, more particularly, to a hierarchical data structure which enables interactive visualization of a geographical space.

### BACKGROUND OF THE INVENTION

Interactive visualization tools are commonly employed in the computer gaming industry. In this application, three-dimensional simulation models rendered by the visualization tool represent a fictitious location. In contrast, constructing three-dimensional simulation models to represent actual geographical locations is an emerging application for interactive visualization tools. In the known applications, interactive visualization tools allow a user to view a particular geographical location as it has been modeled at a given point in time. Although interactively viewing a geographical location has proven to be beneficial to architects, interior designers, city planners and others, known visualization tools provide limited (if any) capability to model the geographical location over time.

Therefore, it is desirable to provide an interactive visualization tool which allows architects, interior designers, city planners and others to build, modify and interactively view three-dimensional simulation models for a given geographical location.

### SUMMARY OF THE INVENTION

In accordance with the present invention, an interactive visualization tool is provided that enables its users to build, modify and interactively view three-dimensional simulation models of a particular geographical space. The interactive visualization tool may employ a scene definition data structure that represents the geographical space. The scene definition data structure is comprised of a plurality of data records, where each data record represents a physical structure residing in the geographical space. Each data record includes an identifier for the physical structure, link data which provides information to access corresponding model data for the physical structure, position data which provides positional information for the physical structure in the geographical scene, and hierarchical data which indicates the number of data records having a child relationship thereto.

For a more complete understanding of the invention, its objects and advantages, reference may be had to the following specification and to the accompanying drawings.

### BRIEF DESCRIPTION OF THE DRAWINGS

FIG. 1 is a block diagram of an exemplary interactive visualization tool in accordance with the present invention;

FIG. 2 is a diagram of a hierarchical tree structure that may be used to represent a geographical space in accordance with the present invention;

FIG. 3 is a flowchart illustrating processing steps for viewing a requested scene in accordance with the present invention;

FIG. 4 is a diagram depicting three hierarchical data structures used to represent a geographical space in accordance with the present invention;

FIG. 5 illustrates an exemplary graphical user interface for the interactive visualization tool of the present invention;

FIGS. 6A and 6B illustrates exemplary pop-up windows which allows a user to modify a visual simulation attribute associated with a physical structure in the requested scene in accordance with the present invention; and

FIG. 7 is a flowchart illustrating an exemplary recursive retrieval process in accordance with the present invention.

### DETAILED DESCRIPTION OF THE PREFERRED EMBODIMENTS

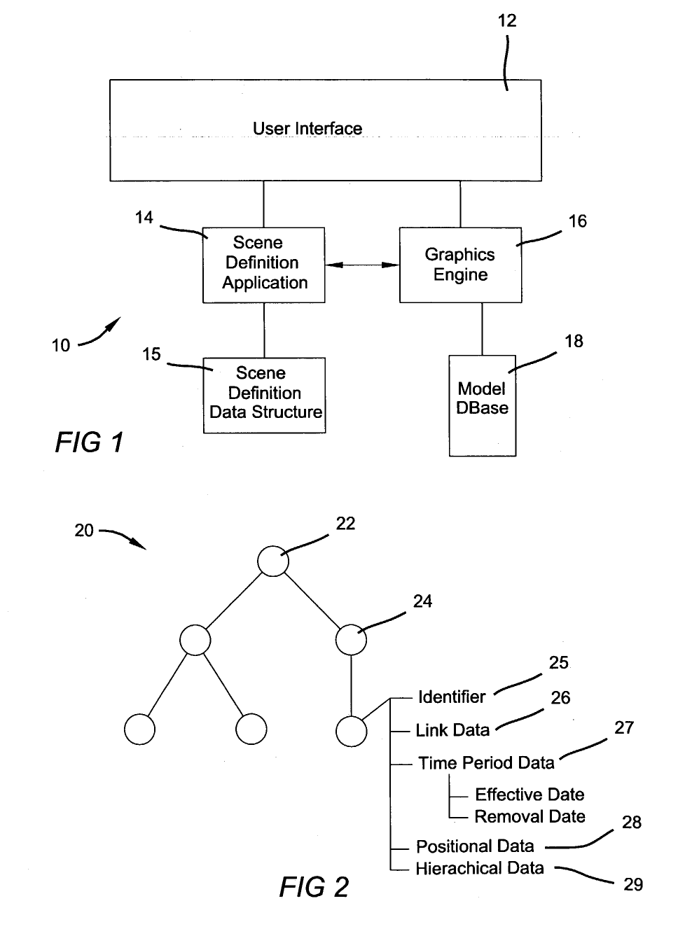

An exemplary interactive visualization tool 10 is depicted in FIG. 1. The interactive visualization tool 10 is a software-implemented application that allows it users to build, modify and interactively view three-dimensional simulation models of a particular geographical space. In accordance with the present invention, the interactive visualization tool 10 allows a user to set a desire point in time. The interactive visualization tool 10 is then operable to interactively display the geographical space in accordance with the specified time.

To represent a geographical space over time, the interactive tool 10 employs a scene definition data structure 15. The scene definition data structure 15 is preferably comprised of one or more hierarchical tree structures, such that each different tree structure represents a different geographical space. For instance, a tree structure may be used to represent the city of Birmingham; whereas another tree structure may be used to represent the city of Troy. Alternatively, one tree structure may be used to represent the greater Detroit metropolitan area, such that the city of Birmingham and the city of Troy are represented by a series of nodes within this one tree structure.

An exemplary hierarchical tree structure 20 is illustrated in FIG. 2. Each tree structure 20 includes a root node 22 and a plurality of branching nodes 24. The root node 22 signifies a particular geographical space; whereas each branching node 24 (either by itself or through its children) represents a physical structure residing in the geographical space. For instance, a branching node may represent a building on a street, a room residing in a building, or an object within the room.

Each branching node is preferably defined to include an identifiable name 25 for the physical structure, link data 26, time period data 27, positional data 28, and hierarchical data 29. The link data 26 provides information, such as a filename, for accessing the corresponding three-dimensional model data for the physical structure. The time period date 27 defines when the physical structure exists in the geographical space. More specifically, the time period may be specified by an effective date and a removal date. The positional data 28 provides location information for the physical structure in the geographical space; whereas the hierarchical data 29 indicates the number of nodes having a child relationship with the branching node. As will be further described below, the hierarchical data 29 facilitates an efficient manner for storing and retrieving data which comprises the hierarchical tree structure 20. It is readily understood that only the most relevant data elements have been described above, but that other types of data elements may further define the nodes of the hierarchical tree structure 20.

In one embodiment, the scene definition data structure 20 may be implemented in an object oriented form, where the nodes are data objects instantiated from a common object class and assembled in a direct acyclic graph; however, other implementations for the scene definition data structure 20 are also within the scope of the present invention. Thus, the scene definition data structure 20 dictates the image data rendered by the interactive visualization tool 10 as further described below.

Returning to FIG. 1, the interactive visualization tool 10 is primarily comprised of a user interface component 12, a scene definition application 14, a graphics engine 16 and its associated model database 18, and the above described scene definition data structure 15. In one embodiment, the visualization tool may be implemented in a Microsoft Windows environment residing on a personal computer. In this embodiment, the user interface component 12 is implemented using standard Windows user interface controls as is known in the art. The scene definition application 14 is preferably a custom developed software application as further described below; whereas the graphics engine 16 and its associated model database 18 may be implemented though custom developed software and/or one of a variety of commercially available software products. An exemplary graphics engine software product is the NetImmerse 3D game engine available from Numerical Design Ltd. of Chapel Hill, N.C.

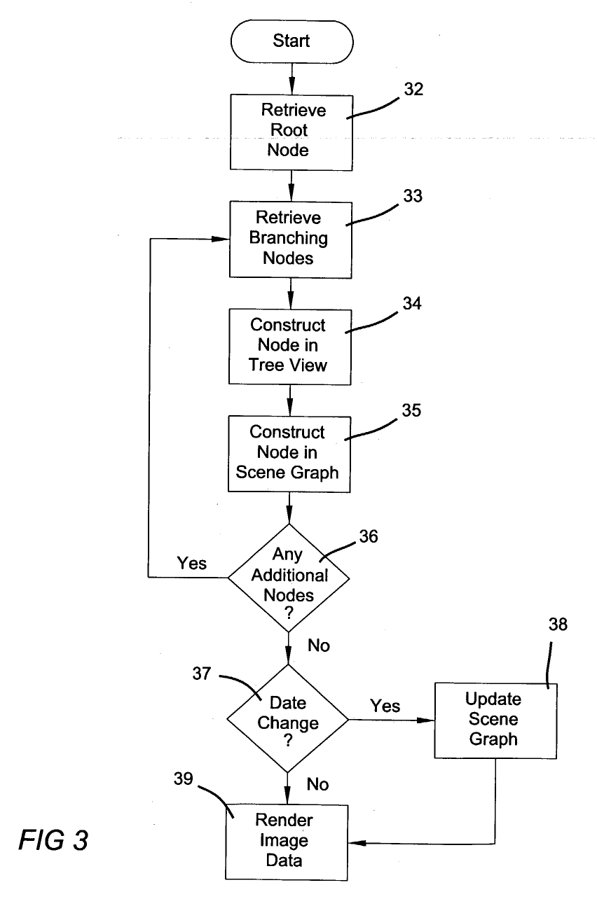

In general, the scene definition application 14 governs the overall operation of the interactive visualization tool 10. To view a scene, the scene definition application 14 performs the processing steps depicted in FIG. 3. It is to be understood that only the relevant steps of the scene definition application are discussed in relation to FIG. 3, but that other software-implemented instructions may be needed to control and manage the overall operation of the system.

Scene definition stems from a root node of a hierarchical tree structure as described above. The scene definition application 14 retrieves a root node for the requested scene from the scene definition data structure 15 as shown at step 32. The scene definition application 14 then retrieves the remainder of the corresponding hierarchical tree structure from the scene definition data structure 20. It is readily understood that the hierarchical tree structure is retrieved into a readily accessible memory space from a persistent data store associated with the computing device.

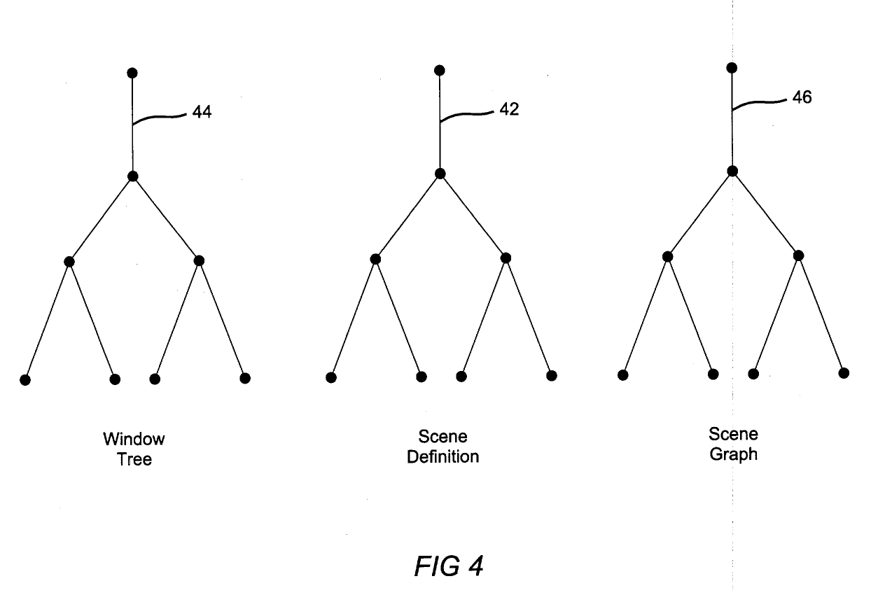

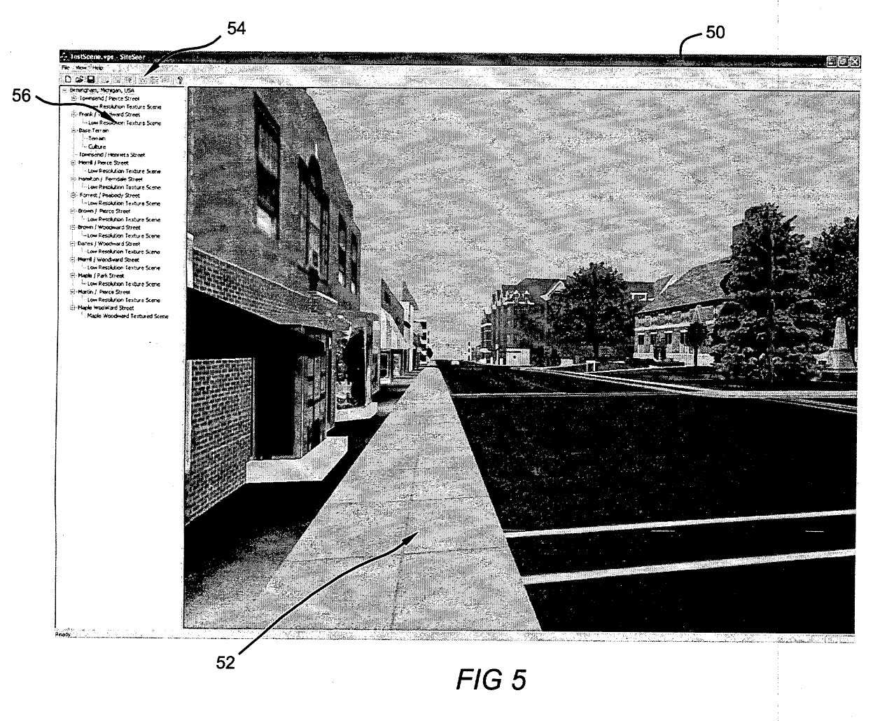

Next, the scene definition application 14 dynamically builds two data structures which parallel the hierarchical tree structure 42 retrieved from the scene definition data structure 15 as shown in FIG. 4. The first parallel data structure is a window tree 44 which is displayed on the graphical user interface of the tool. The window tree may be implemented using the well known tree view function as provided by the standard Windows programming environment. An exemplary window tree 56 is illustrated in FIG. 5. The second parallel data structure is a scene graph 46. The scene graph 46 is a well known hierarchical data structure built and used by the graphics engine 16 to render image data.

To dynamically build these two data structures, the scene definition application 14 traverses the hierarchical tree structure 42 retrieved from the scene definition data structure 15. For each node, the scene definition application 14 requests construction of a corresponding node in each of two parallel data structures.

First, the scene definition application 14 issues a command at step 34 to the Windows operating environment 12. The command (at a minimum) includes the name for the requested node. In response to the issued command, the operating environment instantiates a corresponding node in the window tree 44 and returns a pointer (i.e., memory address) for the node to the scene definition application 14. The pointer data is then stored by the requesting node in the hierarchical tree structure 42.

Second, the scene definition application 14 issues a command at step 35 to the graphics engine. In this case, the command includes link data (e.g., a file name or file address) for the corresponding model data residing in the model database 18 associated with the graphics engine 16. Similarly, the graphics engine 16 creates a corresponding node in the scene graph 46 and returns a pointer to the scene definition application 14. The pointer data is also stored by the requesting node in the hierarchical tree structure 42.

In this way, each node is each data structure represents the same physical structure in the geographical space. In other words, all three data structures represent the same hierarchy, and thus the same geographical space. Of particular importance, corresponding nodes in each data structure are linked together through the pointer data stored at each node in the hierarchical tree structure 42. Thus, the hierarchical tree structure 42 serves as the controlling data structure for the interactive visualization tool.

In accordance with the present invention, the scene definition application 14 renders the scene in accordance with a specified time input by the user. Although not limited thereto, the user specified time is preferably in date format. In one embodiment, the scene definition application 14 prompts the user for a specified view date each time a different scene is requested by the user. Alternatively, the scene definition application 14 may rely on a previously specified view date to render the scene. In this alternative embodiment, the scene definition application 14 allows the user to change the specified view date. In either case, the scene definition application 14 stores the most recently specified view date in a persistent data store.

Prior to rendering the scene, the scene definition application 14 determines whether the user specified view date has changed at step 37. When the specified view date changes, the scene definition application 14 must further update the scene graph 46 as shown at step 38. Each node in the scene graph has a corresponding switch node. Switch nodes are two-way switches that dictate whether three-dimensional model data is rendered by the graphics engine 16. When a switch node is set to a display mode, the model data associated with the node in rendered by the graphics engine 16. On the other hand, when a switch node is set to a non-display mode, the model data associated with the node is ignored by the graphics engine 16. In this way, switch nodes may be used to control the model data rendered in a given scene.

To update the scene graph, the scene definition application 14 recursively traverses each node in the hierarchical tree structure for the requested scene. At each node, the scene definition applications 14 checks the specified view date against the time period embodied in the given node. When the specified view date falls within the time period, the scene definition application 14 issues a request to set the corresponding switch to a display mode. When the specified view date falls outside the time period, the scene definition application 14 issues a request to set the corresponding switch node to a non-display mode. It is envisioned that the scene definition application 14 may be configured to update the switch node only if it needs to be changed. It is readily understood that this determination is easily made from the currently specified view date, the most recently specified view date, and the time period from a given node in the hierarchical tree structure.

Lastly, the image data is rendered in accordance with the specified view date by the interactive visualization tool as shown at step 39. Specifically, the graphics engine 16 retrieves and culls three-dimensional model data from the model database 18 and then translates it to two-dimensional data for display on the graphical user interface of the tool as is known in the art.

FIG. 5 illustrates an exemplary graphical user interface 50 for rendering the scene. The graphical user interface 50 is preferably divided into three components. A primary window 52 displays a three-dimensional representation of the requested scene. Various user commands may then be used to interactively view the scene. User commands, such as mouse position, mouse clicks and keyboard input, are captured by the Windows operating environment. User commands which are intended to manipulate the scene are directly passed to the graphics engine 16. The graphics engine 16 in turn responds to the commands by rendering the appropriate image data for the scene as is known in the art.

The interactive visualization tool 10 also allows a user to modify visual simulation attributes associated with the scene. To facilitate this user interaction, the graphical user interface 50 further includes a tool bar 54 disposed along the top of the display and a window tree 56 disposed along the left side of the display. As described above, the window tree 56 includes a branch for each physical structure residing in the geographical space. To change an attribute associated with a particular physical structure, the user selects the applicable branch from the window tree.

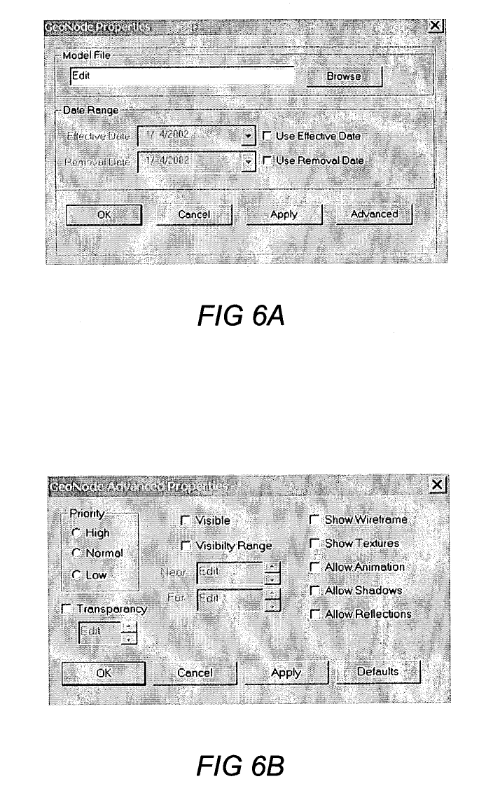

A pop-up window is then displayed to the user as shown in FIGS. 6A and 6B. The pop-window may be used to changes various attributes associated with the physical structure. Of particular importance, the interactive visualization tool 10 allows the user to set a time period during which the physical structure exists in the geographical scene; other modifiable attributes may include (but is not limited to) color, size, or material of the physical structure. It is readily understood that user input data for such modifiable attributes is embodied in the corresponding node of the hierarchical tree structure 42.

In another aspect of the present invention, a preferred storage and retrieval mechanism for the scene definition data structure 15 is further described below. Data for the scene definition data structure 15 starts with a document that is derived from CDocument of the Microsoft Foundation Classes. Referring to FIG. 2, this document holds a pointer (referred to as RootNode) to the head of a tree graph of nodes (i.e., root node 22). In other words, RootNode is a variable that stores the address of the root node 22. Since all of the nodes have pointers to their parent and child nodes, the pointer to the root node is all that is needed to access the data structure.

The tree graph has a parent-child relationship that can be traced in either direction. When the scene definition application 14 stores data, it uses the RootNode pointer to call the well known Serialize function as provided by Microsoft Foundation Classes. By calling the Serialize function for the root node, the application begins a recursive process of writing out all of the nodes and inherently saving the parent-child relationship among the nodes. Pseudocode for saving a node is as follows:

ar << Perspecvtive_Version_Number; //Version number of the
application

| | |
|---|---|
| ar << (int) DefUnits | //Default units for the whole scene |

| | |
|---|---|
| ar << TreeText; | //Label for user interface |
| ar << Filename; | //Filename that points the model data file |
| ar << pathtype; | //Type of path the filename uses |
| ar << IsClone; | //Is the object a clone of it's parent? |
| ar << URL; | //Webpage to link to |
| ar << (int) objectunits;; | //Units for this object |
| ar << objectscale; | //Scale for this object |
| ar << UseEffDate; | //Are we using the effective date? |
| ar << EffDate; | //The effective date |
| ar << UseRemDate; | //Are we using the removal date? |
| ar << RemDate; | //The removal date |
| ar << visible; | //Is the object visible? |
| ar << texture; | //Should we render the texture map(s)? |
| ar << wireframe; | //Should we render it is wireframe? |
| for(i=0;i<3;i++) | //Positional information for this object |

for(j=0;j<3;j++)

ar << pos_rotate.GetEntry(i,j);
ar << pos_trans.x;
ar << pos_trans.y;
ar << pos_trans.z;

| | |
|---|---|
| for(i=0;i<3;i++) | //Favorite viewing position for this object |

for(j=0;j<3;j++)

ar << fav_rotate.GetEntry(i,j);
ar << fav_trans.x;
ar << fav_trans.y;
ar << fav_trans.z;

Each data record further includes hierarchical data which indicates the number of other data records having a child relationship thereto. The recursive process then calls the Serialize function for each child as follows:

if (noc)
{

for(i=0; i<noc; i++)
((CInsightNode*) children[i])−>Serialize(ar, pStructureView,pDoc);

}

In particular, it calls each child in order, one after the other. If a given child record itself has children, then the Serialize function is also called for each of these children. This allows the graph to be saved in a predictable manner (i.e., top to bottom and left to right) which can be replicated when the data is retrieved from the persistent data store.

When data is retrieved from the persistent data store, it is read back in the same order as it was written. In other words, the retrieval process is similar to the process described above, except that a data structure must be created in accessible memory space for storing the data.

To retrieve data, the scene definition application 14 first creates a new node and links the RootNode variable to that node. Next, it calls the Serialize function for that node, such that data for the node is loaded into memory. The scene definition application 14 also builds the window tree 44 and the scene graph 46 as described above. Lastly, the scene definition application 14 determines if the node has any children nodes. If so, it creates a node and calls the Serialize function for each child as follows:

int noc;
ar << noc;
for(i=0; i<noc; i++)

{
tempnode = new CInsightNode;
childrem.Add(tempnode);
tempnode−>SetParent(this);
tempnode−>Serialize(ar, pStructureView,pDoc);
}

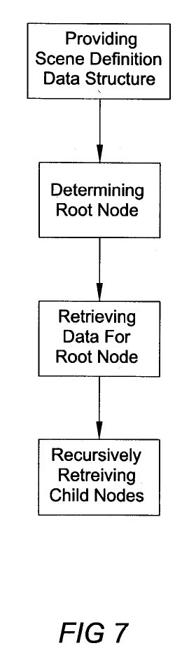

This has the effect of recursively rebuilding the tree graph in the same order as it was written out. This recursive retrieval process is illustrated in FIG. 7.

While the invention has been described in its presently preferred form, it will be understood that the invention is capable of modification without departing from the spirit of the invention as set forth in the appended claims.

What is claimed is:

1. A computer-implemented system that enables interactive visualization of a geographical scene having one or more physical structures residing therein, comprising:
a model database for storing three-dimensional model data for the physical structures which may reside in the geographical scene;
a scene definition data structure that represents the geographical scene, the scene definition data structure being comprised of a plurality of data records, where each data record represents a physical structure residing in the geographical scene, each data record further includes an identifier for the physical structure, link data which provides information to access corresponding model data for the physical structure, position data which provides positional information for the physical structure in the geographical scene, and hierarchical data which is indicative of data records having a child relationship thereto; and
a scene definition application connected to the model database and the scene definition data structure, the scene definition application operable to retrieve the plurality of hierarchical data records and interactively display the geographical scene.

2. The computer-implemented system of claim 1 wherein the plurality of data records of the scene definition data structure are arranged in a tree structure.

3. The computer-implemented system of claim 2 wherein the scene definition application is operable to dynamically build a window tree which parallels the tree structure of the scene definition data structure, where the window tree is displayed on a graphical user interface of the system.

4. The computer-implemented system of claim 3 wherein the identifier for the physical structure is further defined as a text label that identifies the physical structure in the window tree which is displayed on the graphical user interface.

5. The computer-implemented system of claim 1 wherein the link data is further defined as a filename for the corresponding model data in the model database.

6. The computer-implemented system of claim 1 further includes a graphics engine, the graphics engine being cooperatively operable with the scene definition application to render the model data for each physical structure displayed in the geographic scene.

7. The computer-implemented system of claim 6 wherein the scene definition application cooperatively operable with the graphics engine to dynamically build a scene graph which parallels the scene definition data structure, the scene graph being used by the graphics engine to render the model data for each physical structure displayed in the geographic scene.

8. The computer-implemented system of claim 1 wherein each data record further includes time period data which defines when the physical structure exists in the geographical scene.

9. The computer-implemented system of claim 8 wherein the scene definition application displays physical structures in the geographical scene, where the specified time falls within the time period associated with each physical structure displayed in the geographical scene.

10. A data record for storing hierarchical scene data that represents a geographical scene, the data record embodied in a computer readable medium, comprising:
an identifier for a physical structure residing in the geographical space;
link data which provides information to access three-dimensional model data for the physical structure;
positional data which provides location information for the physical structure in the geographical scene; and
hierarchical data which is indicative of other data records having a child relationship to said data record.

11. The data record of claim 10 wherein the identifier is further defined as a text label that describes the physical structure.

12. The data record of claim 10 wherein the link data is further defined as a filename for the model data in a model database.

13. The data record of claim 10 wherein the hierarchical data is further defined as a number of data records having a child relationship to said data record.

14. The data record of claim 10 further comprises time period data which defines when the physical structure exists in the geographical scene.

15. The data record of claim 14 wherein the time period data is further defined as an effective data and a removal date.

16. A method for retrieving scene definition data that represents a geographical space having one or more physical structures residing therein, comprising:
providing a scene definition data structure that represents the geographical space, the scene definition data structure comprised of a root node and a plurality of associated nodes, such that each node represents a physical structure residing in the geographical scene;
determining an address for the root node of the scene definition data structure;
retrieving a data record for the root node based on said address, said data record including hierarchical data which indicates first generation data records having a child relationship to said data record; and
recursively retrieving the first generation data records based on the hierarchical data in the data record for the root node.

17. The method of claim 16 wherein each of the first generation data records further includes additional hierarchical data which indicates second generation data records having a child relationship to the said first generation data record and further comprises recursively retrieving the second generation data records for a given first generation data record prior to retrieving an adjacent first generation data record.
